(19) United States
(12) Patent Application Publication
(10) Pub. No.: US 2016/0225079 A1
(43) Pub. Date: Aug. 4, 2016

(54) ADAPTIVE INTELLIGENT SYSTEMS AND/OR METHODS FOR DEVELOPING AND MATCHING PROFILES TO FURTHER IDENTIFY AND/OR QUALIFY PATTERNS ASSOCIATED WITH INDEPENDENTLY-VERIFIED INDIVIDUALS

(71) Applicant: GORION LLC, New York, NY (US)

(72) Inventors: Christopher M. TISO, New York, NY (US); Ari KAREN, Potomac, MD (US); Darren PORT, Short Hills, NJ (US)

(21) Appl. No.: 15/013,766

(22) Filed: Feb. 2, 2016

Related U.S. Application Data
(60) Provisional application No. 62/111,189, filed on Feb. 3, 2015.

(51) Int. Cl. G06Q 40/02

(52) U.S. Cl. CPC G06Q 40/025

(57) ABSTRACT

Certain example embodiments relate to techniques for adaptively and intelligently identifying and/or qualifying patterns associated with individuals who are independently certified in accordance with independent verification rules (e.g., for repaying a loan). Based on received first information related to the borrower, educational modules and verification questions are determined. Second information related to the borrower is received, based upon responses provided by the borrower in real-time, to questions presented. Questions are determined dynamically, based upon the first information and responses collected thus far. During collection, the borrower is provided access to educational modules, selectively, based upon the first information and responses thus far collected. Based upon the first and second information, a ratio of residual income to average gross income for the borrower is determined and evaluated based upon rules associating the two. Based upon the evaluating, a risk status associated with the ability to repay is determined.

### CROSS REFERENCE TO RELATED APPLICATIONS

This application claims priority to U.S. provisional patent application No. 62/111,189 filed on Feb. 3, 2015, the contents of which is hereby incorporated by reference in its entirety.

### TECHNICAL FIELD

Certain example embodiments described herein relate to techniques for computer software processing. More particularly, certain example embodiments relate to techniques for adaptively and intelligently identifying and/or further qualifying patterns associated with individuals who are independently certified in accordance with a first set of verification rules.

### BACKGROUND AND SUMMARY

New rules crafted by the Consumer Financial Protection Bureau in January 2014, imposed new and unpredictable risks for lenders of money and made it substantially more difficult for even financially-sound consumers to obtain the financing essential to purchase or refinance a home. Mortgage loans are divided into two types: Qualified and Non-Qualified Mortgages. Qualified mortgage loans, or QM loans as they are often called, are granted a safe harbor from liability under the “Ability to Repay” (“ATR”) laws, whereas Non-QM (NonQM) loans are subject to new and unpredictable liabilities that can impact lenders for as long as 29 years after the loan is closed. Thus, although the NonQM market is expected to reach US $600 billion by the end of 2017, because of the increased risk exposure associated with this type of loan, many financial institutions, including banks, refrain from making these loans, even when the borrower is adequately qualified. The end result is that very few lenders are willing to make NonQM loans, which represent approximately 15% of the mortgages made today.

Although one would think NonQM loans must, by their very nature, have substantially more risk to warrant their disfavored status, many (if not most) NonQM loans involve well-qualified and established buyers whose circumstances fall outside the predetermined government qualifications. As such, those who are self-employed, those relying upon savings/inheritance, those who have sufficient income but require lower down-payments, those with large amounts of discretionary income but higher debt to income ratios, among others, may often find themselves unable to borrow money for a home purchase—even though their risk of defaulting is as low as, or even lower than, those meeting the criteria for a qualified mortgage.

Lenders are often hesitant to capitalize on the opportunities that come with providing NonQM loans because, in their view, the risk of litigation outweighs the benefits.

Example embodiments described herein may be used to assist mortgage banks make more profitable loans and to reduce the risks associated with certain types of lending, such as, NonQM lending. Example embodiments achieve reduced risk and also educates borrowers on the mortgage process and terms of their loans. Certain embodiments provide a verification system, that may be implemented by a third party, which may be integrated into any loan origination system, that protects lenders from risks associated with NonQM loans including ATR risk.

In certain example embodiments, there is provided a system for verifying a borrower's ability to repay a loan. The system comprises processing resources including memory and at least one processor. The processing resources are configured to control the system to perform operations comprising: receiving first information related to the borrower; determining, based on the received first information, a set of educational modules and a set of verification questions; collecting second information related to the borrower based upon responses provided by the borrower in real-time to a series of questions presented, wherein questions for the series are determined from the set of verification questions dynamically based upon the first information and said responses so far collected, and wherein during the collecting the borrower is provided access to one or more educational modules in the set of educational modules selectively based upon the first information and said responses so far collected; determining, based upon the first information and the second information, a ratio of a residual income to an average gross income for the borrower; evaluating the ratio based upon a predetermined set of rules associating average gross incomes and residual incomes; determining, based upon the evaluating, a risk status associated with the borrower's ability to repay the loan; and producing an output based upon the determined risk status.

Corresponding methods and/or computer readable storage media tangibly storing instructions for implementing same also are contemplated herein.

These aspects, features, and example embodiments may be used separately and/or applied in various combinations to achieve yet further embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a block diagram of a system environment including a borrower risk assessing system according to some example embodiments;

FIG. 2 is a block diagram illustrating some components of a borrower risk assessing system according to some example embodiments;

FIGS. 3A and 3B illustrate a flowchart representing a borrower risk assessment process according to some example embodiments;

FIG. 4 illustrates aspects of a residual income assessment formula in accordance with some example embodiments;

FIG. 5 illustrates a process for posing automatically selected questions according to certain example embodiments;

FIG. 6 illustrates an example display screen for posing borrower questions according to certain example embodiments;

FIG. 7 illustrates an example display screen for posing loan process verification questions according to certain example embodiments;

FIG. 8 illustrates an example display screen for posing income-related questions according to certain example embodiments;

FIG. 9 illustrates an example display screen for posing expense-related questions according to certain example embodiments;

FIG. 10 illustrates a flowchart for computing the residual income according to certain example embodiments;

FIGS. 11A and 11B illustrate a screen with a spreadsheet for determining residual income certain example embodiments; and

FIG. 12 illustrates an example display screen from an educational module, according to certain example embodiments.

### DETAILED DESCRIPTION OF CERTAIN EXAMPLE EMBODIMENTS

Certain example embodiments relate to techniques for adaptively and intelligently identifying and/or further qualifying patterns associated with individuals who are independently certified in accordance with a first set of verification rules. For example, certain example embodiments relate to techniques that reduce the risk undertaken by lenders who lend money for mortgages or other reasons. Certain example embodiments may be particularly beneficial in reducing the risk assumed by a lender making a NonQM loan. It will be appreciated, however, that embodiments are not limited to lending for NonQM. Certain example embodiments can help revitalize lending in the NonQM market. These embodiments provide an industry leading technology and insurance solution that is aimed at reducing lender risk by providing a valuable defense against, for example, ATR claims, while also educating borrowers on the mortgage process and terms of their loans.

Example embodiments reduce lender risk by providing verification conforming that borrowers have the ability to repay their loans. The verification system can be implemented by a third party. Certain example embodiments include techniques for income/expense determination, along with online assessments, educational videos and other web-based tools that mortgage originators use during the underwriting approval process. The verification according to certain example embodiments provides the mortgage loan originator (“lender”) confidence that the borrower has the ability to repay the loan, and is educated on the mortgage lending process. It will be appreciated that certain example embodiments operate in parallel with, but not as a part of, the underwriting process. That is, certain example embodiments provide an indication of risk that is independent of the risk associated with underwriting. Indeed, as those skilled in the art can appreciate, the risks assessed by certain example embodiments may exist even though underwriting suggests that loans should be approved. In this sense, certain example embodiments provide techniques that apply rules designed to mitigate and/or assess risk, even though one or more other sets of rules indicate or suggest that there is an acceptable amount of risk.

Embodiments can provide a defense against the risk inherent in NonQM lending by providing that borrowers are educated on the specifics of their loan, checking that there are no improper origination activities, and by providing a neutral third party confirmation of the borrower's ability to repay. Embodiments may include an online system with questions and educational modules that borrowers can review conveniently to complete and enhance their knowledge about the loan and options. Easy to understand series of questions, adaptively customized to each borrower, helps reduce the likelihood of misunderstandings and potential misrepresentations associated with the loan. An automated residual income analysis is completed that confirms the borrower's ability to repay. For loans that are recommended (e.g., loans that are verified by the example embodiments), a certificate may be generated, and the certificate may help confirm that the lender can approve the loan without the risks, or with substantially reduced risks, typically associated with NonQM loans.

The lender has access to a library of video content that can be used to educate borrowers on their loans. The borrowers can personally confirm the system's conclusions regarding the borrower's ability to repay. The borrower's answers are matched against the actual loan (or actual loan application) ensuring that the borrower understands the loan. The questions may be used to propose a budget for the borrower based on gross income, and the borrower may be enabled to confirm the system's automatically determined conclusions. These questions, among other things, address commonly alleged material misrepresentations and are directed to ensure that they do not occur in the loan.

Certain example embodiments include a monitoring system to keep track of which of the processed loans subsequently result in a claim of default or non-payment. Other post verification aspects, such as whether there were claims asserted for steering, low level of benefit to borrower, misrepresentations, can also be kept track of. These tracked post verification aspects can be used in selecting effective verification questions and/or educational modules to be provided to the borrower.

The NonQM verified loan provided in accordance with certain example embodiments is the result of a process that closes the gaps left by conventional origination, processing and underwriting protocols that often result in claims against lenders. Specifically, the NonQM verified loan diminishes risks by establishing a lender's good faith belief of a borrower's ability to repay through the opinions and actions of independent third parties approving all or most aspects of the NonQM loan. The concept of a good faith belief is not unique to mortgages: If a party can point to a legitimate third party opinion on which it relies, it usually establishes the requisite good faith belief.

The process for the third party verification of the NonQM verified loan, according to certain example embodiments, has three phases. The first phase involves confining the structural integrity of the lender's compliance and underwriting infrastructure. The second phase involves enhanced borrower communications that are verified in terms of content and delivery. The final phase involves software that assesses a borrower's ability to repay. The ability to repay may be determined from a cash flow analysis that considers many real-world circumstances—currently overlooked in traditional lending—that unfortunately can put borrowers into difficult situations when it comes to making payments on loans.

The first part of the process is directed to helping to ensure that the lender has a sufficient compliance infrastructure, underwriting controls, and protocols from a NonQM lending perspective. The next phase provides pre-scripted videos and/or audio (e.g., approved by legal counsel and/or other relevant parties) relevant to NonQM lending that will be automatically or otherwise be provided to borrowers at appropriate times during the loan process and tracked in terms of when and how many times they are viewed by the borrower.

The last phase includes the use of software to verify that the borrower fully understands his/her obligations under the loan and possesses sufficient resources to make the mortgage payments. The software uses a series of questions, adaptively and intelligently selected, answered by the borrower confirming that the borrower understands the financial realities, the loan terms, and confirms his/her ability to repay. If the borrower answers the questions incorrectly or cannot provide answers, the loan may not be certified as a NonQM verified loan. For example, if a borrower cannot describe basic loan terms, the loan will not be permitted to go forward. Moreover, if the borrower's disposable income is deemed insufficient either by the borrower or the system's predetermined standards, the loan will be rejected from a cash flow basis. In addition, certain life expenses that are commonly prioritized over a mortgage are included in the cash flow analysis even though they are not typically considered in underwriting a qualified loan. As another measure of security, some example embodiments may send out a customer survey 24 hours after closing that confirms that the borrower has read the loan documents and obtained answers to any outstanding questions. These operations combine with others to effectively foreclose claims against lenders, as well as claims under the ATR by relying upon the borrower's own statements to prove the good faith basis for a lender's actions.

Overall, embodiments help satisfy the interests of both lenders and borrowers. By eliminating or reducing risks of baseless litigation upfront, the NonQM verified loan enables the delivery of a loan product that lenders desire to supply, and borrowers want. The NonQM verified loan, determined according to certain embodiments, may be guaranteed by insurance so that all or most of the uncertainty that surrounds NonQM lending will dissipate so that banks can get back to the business of lending and stop worrying about what lawsuit they will be served with. The NonQM systems of example embodiments, among other things, allow lenders to open up additional revenue streams while reducing the financial risks associated with litigation.

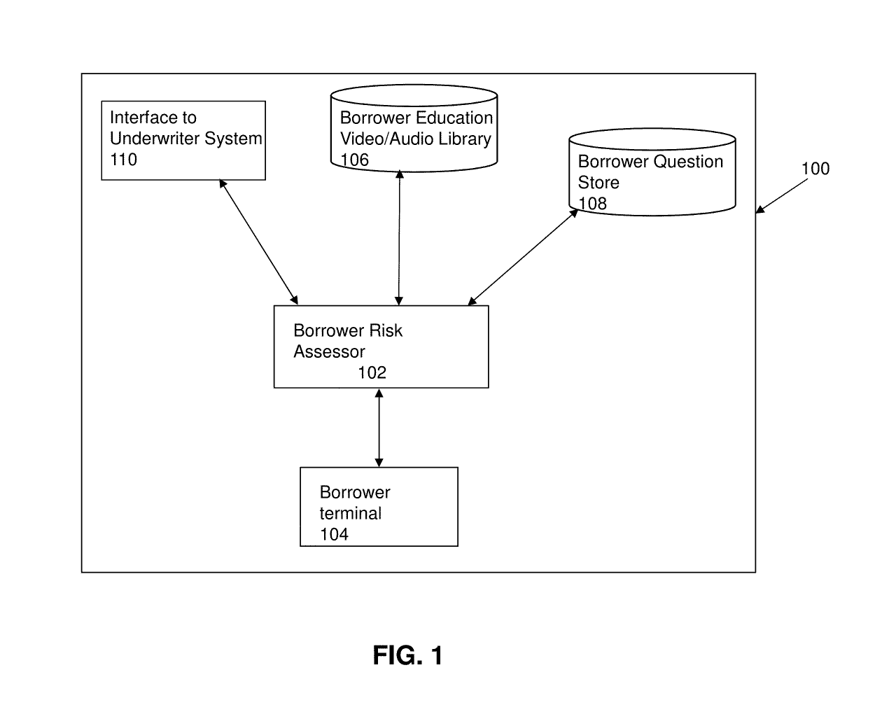

FIG. 1 is a block diagram of a system environment 100 including a borrower risk assessing system according to some example embodiments. Borrower risk assessing system 102, according to certain example embodiments, may be used for providing verification of NonQM loans discussed above.

System environment 100 comprises the borrower risk assessor 102 and a borrower terminal 104. Also communicably linked to borrower risk assessor 102 are a borrower video/audio library 106, a borrower question store 108, and an interface 110 to an underwriting system.

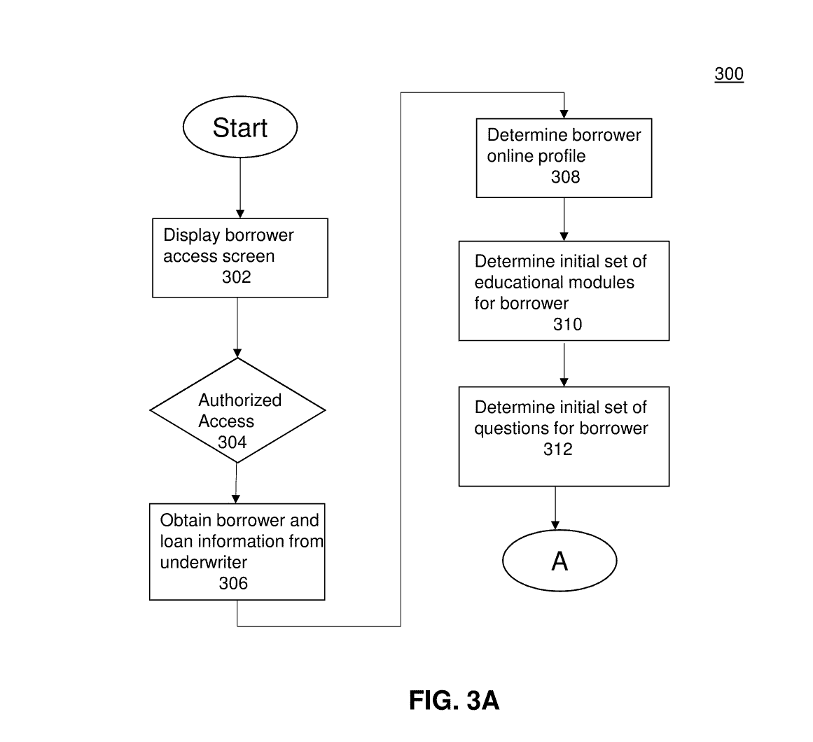

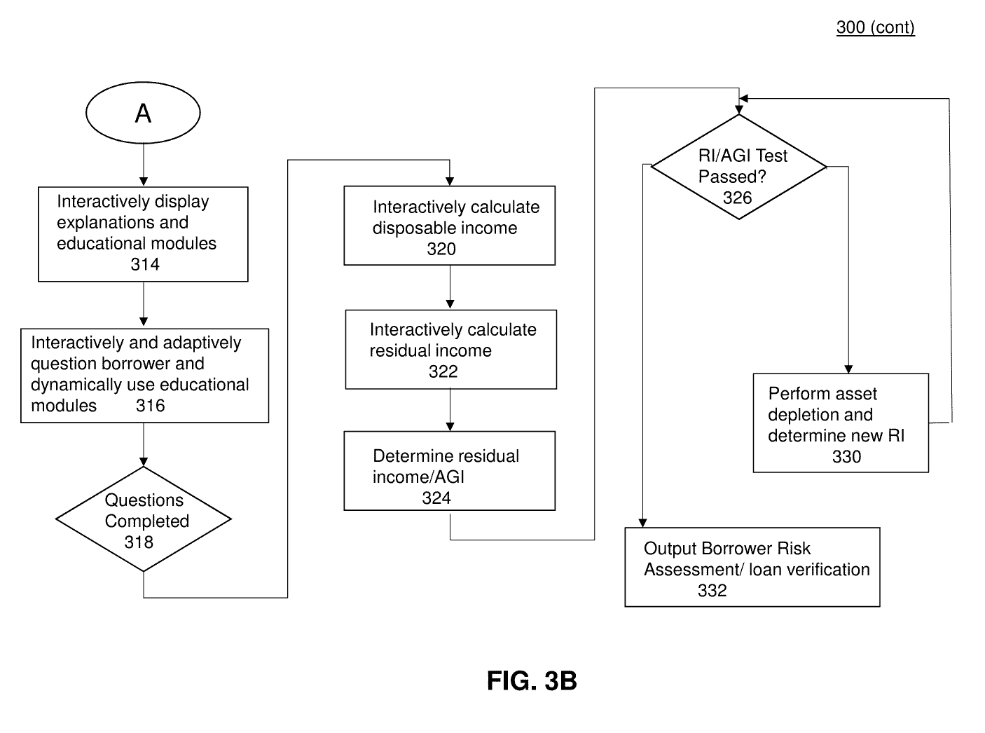

Borrower risk assessor 102 operates to assess the risk associated with lending to a particular borrower, and to subsequently provide, if appropriate, a verification of the loan to be made. In some example embodiments, borrower risk assessor performs the process described in relation to FIGS. 3A-3B.

Borrower terminal 104 provides audio/video output capability for presenting the user with the output of the borrower risk assessor, and input capability so that the user is able to provide input, for example, in response to questions posed to the borrower by the borrower risk assessor 102.

Borrower video/audio library 106 comprises a collection of pre-recorded video and/or audio recordings. The collection is stored in a searchable manner in volatile and/or non-volatile memory. The collection may be stored using a commercially available database management system or other data organization technique. One or more indices, associating each stored recording with any of a title, one or more keywords, one or more recording types, etc. The collection includes software to receive requests for recordings and, in response, to retrieve and return to the requestor, one or more recordings from the collection in accordance with received selection criteria. The selection criteria may be any one or more of, for example, a filename of the recording, a title of the recording, a keyword associated with the recording, a type associated with the recording, etc.

Each of the recordings may include educational content directed to enhancing a user's (e.g., borrower's) knowledge of a particular subject or item, and/or to testing the borrower's knowledge of a particular subject or item. The particular subjects or items that the recordings are directed may be a subset of the subjects and items regarding which a borrower is questioned during the process described in relation to FIGS. 3A-3B. Each of the recordings may have been reviewed for accuracy and completeness from one or more of a subject matter viewpoint and a legal viewpoint. For example, a mortgage loan expert may review respective recordings for technical accuracy and completeness of the content, and an attorney may review the respective recordings to ensure that the content and the manner of presentation is consistent with good faith providing of sufficient relevant information to the borrower.

Borrower question store 108 comprises a collection of previously determined questions (also referred to herein as “verification questions”). The stored questions may be in text form, audio form, video form or in a combination thereof. The question store 108 may be stored in volatile and/or non-volatile memory, and includes the capability to receive requests for questions and, in response, to retrieve and return one or more stored questions in accordance with received selection criteria. The selection criteria may be a question number, range of question numbers, a type associated with the questions, etc. One or more indices may associate respective stored questions with question numbers, question types, etc.

Interface 110 to an underwriting system provides the borrower risk assessor with the capability to, upon request or automatically, receive information regarding a loan from an underwriter. Interface 110 is configured to be capable of interacting with one or more underwriter computing systems. For example, interface 110 may include the capability to have a plurality of configurations, each configuration including the information necessary for requesting and receiving, via an application programming interface (API) of an underwriter system. The API may identify at least a set of uniform fields for essential information related to the borrower as needed by the borrower risk assessor 102. Interface 110 may include the capabilities to retrieve the entirety of information regarding a loan and/or borrower from an underwriter in one or more files in response to a single request, or to retrieve parts of the entire information. In some embodiments, interface 108 may include the functionality to retrieve the underwriter information relating to a borrower (e.g., information relating to the borrower with respect to the loan) from local storage. For example, in some embodiments where the information from the underwriter is made available in a flash drive or the like, interface 108 may include the functionality to perform any necessary encryption and/or decompression to retrieve the information from the flash drive attached as local storage.

Persons skilled in the art will understand that borrower risk assessor 102, terminal 104, audio/video library 106, question store 108, and interface 110 may each execute on a separate computer, they may all execute on the same computer, or any two or more of them may be on the same computer. The computers hosting the processes for 102-110 may communicate with each other over the internet or any other network. Interface 108 may communicate with an underwrite system via the internet or any other network. These computers may include processing resources including, for example, one or more hardware processors, memory, etc. They also may include network interfaces, e.g., for communicating information over the Internet and/or the like. For instance, one or more of the computers may be web servers that present webpages and/or the like to users (e.g., borrowers or perspective borrowers), and these webpages may include web forms that present questions, a framework for presenting educational videos, etc. Web servers also may include code for determining which questions to ask, which videos to present, etc.

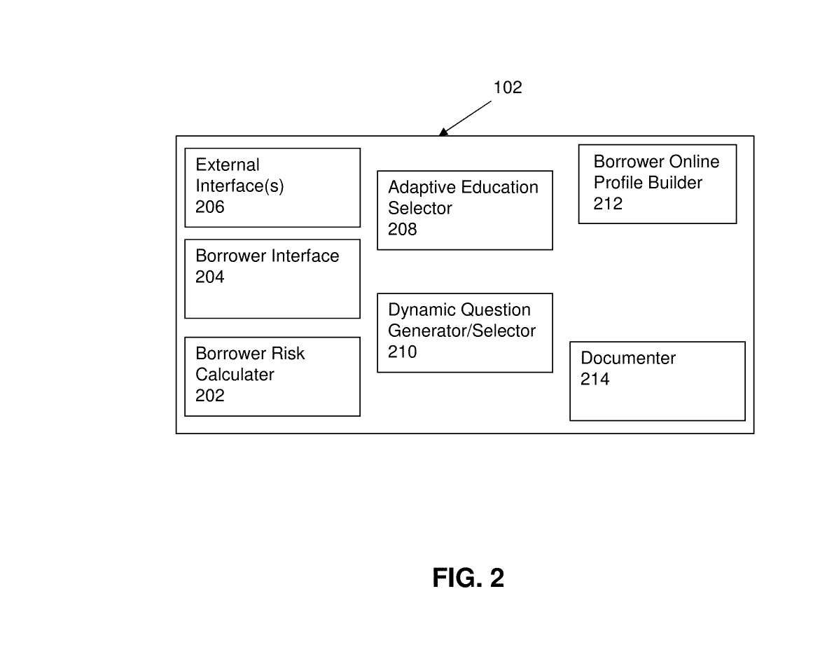

FIG. 2 is a block diagram illustrating a collection 200 of components of a borrower risk assessing system 102, according to some example embodiments.

Components 200 includes a borrower risk calculator 202, borrower interface 204, external interfaces 206, adaptive education selector 208, dynamic question generator/selector 210, borrower online profile builder 212, and documenter 214. Each of the components 200 may comprise one or more software processes.

Borrower risk calculator 202 operates to coordinate the collection of information regarding the borrower and the loan, and to determine the risk associated with making a loan to a borrower.

Borrower interface 204 includes the functionality to interface with the borrower terminal 104.

External interfaces 206 include the functionality to interface with external systems, such as, for example, one or more underwriter systems from which underwriting information regarding a loan can be downloaded.

Adaptive education selector 208 operates to select video/audio recordings from library 106. The selection of the recordings may be performed adaptively in accordance with the progression of questions posed to the borrower during the risk evaluation process.

Dynamic question generator/selector 210 operates to select and/or generate questions to be posed to the borrower during the risk evaluation process. The questions may be selected from the question store 108. In some instances new questions may be generated by supplementing one or more questions from question store 108.

Borrower online profile builder 212 operates to collect information from the questions posed to the borrower, internet searches, subscription services, and/or social media, and to construct a profile of the borrower. The profile may be static or dynamic. For example, in some instances, a borrower profile may be determined prior to the beginning of the borrower's loan evaluation process, and in some instances, the determined profile may continue to be changed based upon new information even during the loan evaluation process. The profile of the borrower may be matched to one or more of a plurality of predefined profiles, e.g., to develop a snapshot of the borrower. In certain example embodiments, the predefined profiles may be constructed adaptively, e.g., based on input from a plurality of borrowers, clustering around certain predefined characteristics (e.g., total household income; actual and/or projected monthly spending; sought-after loan terms such as size of loan desired, interest rate, and/or length; etc.), feedback as to how approved borrowers perform in terms of default or paying off their mortgages on-time or ahead of schedule, etc. Matching may be based on finding a nearest neighbor, by clustering (e.g., using k-means clustering), and/or any other suitable technique.

Documenter 214 operates to document the loan evaluation process and the outcome of the evaluation process. As described above, certain embodiments are directed to reducing the litigation risk associated with making loans. For that purpose, information is documented in order to establish good faith dealing with the borrower. Therefore, in addition to documenting the end result of the evaluation process, documenter 214 also saves, in non-volatile memory, the entirety or at least selected portions of the questions and responses in order to establish the required good faith and to build a coherent record. In some example embodiments, at least some of the borrower responses to verification questions may be provided in audio, and the documenting may include documenting borrower responses in text or audio/video formats. Additionally, the documenting may also include recording, in text, audio or video, the borrower interactions with one or more educational modules. Documenting borrower interactions with the educational modules provide strong evidence of the borrower's interaction with the education modules.

Each of the components 202-214 may be implemented, in certain example embodiments, as one or more software processes. Persons skilled in the art will understand that, in certain embodiments, two or more components 202-214 may be implemented together.

FIGS. 3A and 3B illustrate a flowchart 300 representing a borrower risk assessment process according to some example embodiments.

After entering process 300, at operation 302, the borrower access screen is displayed in the borrower terminal 104. The initial access screen may be in the form of a webpage or any type of introductory screen. The initial screen may include data input fields for the borrower to enter identification information. For example, identification information may include any one or combination of, the loan application number, lender provided password or security identifier, borrower name, social security number, home address, other associated address (e.g., property to be purchased with the loan), cell or home phone number, date of birth, etc. Upon entry, by the borrower, of the appropriate identification information, at operation 304, the borrower identification information entered by the borrower is processed to determine whether the borrower is authorized to access the system.

At operation 306, if the borrower is authorized to use the system, loan information for the borrower is obtained from the underwriter. In certain embodiments, the underwriter information pertaining to the loan is previously prepared. For example, the underwriter may provide the lender (who is controlling performance of process 300) with a prepared file including at least a subset of the information from the underwriting process. The subset of the information may include information from the loan application submitted by the borrower, and/or may include various determinations made by the underwriter. The information provided by the underwriter may include terms of the pending loan, estimated monthly payment. The information made available from the borrower's loan application may include income, savings/investments, current mortgages/rent and other debt obligations, and current liabilities. In certain example embodiments, the information obtained from the underwriter may include some or all of the following and/or other parameters: loan number, amount of payment including private mortgage insurance, amount of all other monthly fixed payments, total monthly obligations, zip code of property, amount of gross income from tax returns of last 2 years, amount of taxes owed for last 2 years, number of dependents listed on tax return plus borrower and spouse, calculated disposable income, indication whether or not all underwriter processes have been followed, indication of any exceptions to the underwriting processes, indication whether all assets and liabilities have been verified, indication as to any suggestion of inaccuracy of borrower provided information, type and terms of loan, total savings and investments amount, and whether or not the borrower possesses 90 days reserves. The information obtained from the underwriter is used, among other things, to cross check against the information provided by the borrower during the verification performed by process 300.

At operation 308, the borrower's online profile is determined. The online profile is generated based upon the underwriter provided information. The profile may include and/or be derived from, for example, any of, borrower identifying information, employment information, date of birth, borrower income as specified in the tax returns, borrower's expenses (e.g., as estimated based upon the number of dependents and other information such as mortgage information specified in the tax returns), amount of tax paid, loan amount (available to the underwriter from the loan application), etc. Additionally, further information that can be obtained about the borrower without inquiring from the borrower can be used to further modify the online profile. Such further information may include information about the borrower that can be determined based upon an internet search, social media web sites, or the like, that may be performed in real-time.

Certain example embodiments may employ an intelligent web crawler to collect and analyze information regarding the borrower. For example, the web crawler, using the name of the borrower and some additional information such as current employment, may access the borrower's online profiles in various social media outlets, and determine such aspects as, whether the borrower has worked for a greater number of employers than a threshold, whether the borrower has derogatory information posted regarding him/her, whether the borrower is listed under a higher than a threshold number of street addresses and/or phone numbers, etc. The web crawler obtained information may also include educational or other qualifications and honors obtained by the borrower that can be found online.

The online profile may have a predetermined format. At this stage, the initial online profile for the borrower may or may not have all the fields of the profile populated. As described below, the initial profile may be modified as the verification process progresses.

At operation 310, an initial set of education modules is determined for the borrower. The initial online profile is used to select an initial set of educational modules. For example, if this is the borrower's first mortgage, that borrower may be assigned a larger set of educational modules, than another borrower with similar characteristics but for whom this is not the first mortgage. Other characteristics of the borrower, as determined from the profile, can be used for determine the initial set of educational modules. The initial set of educational modules can be selected from, for example, the library of educational modules 106 shown in FIG. 1.

At operation 312, an initial set of questions is determined for the borrower. Similar to the manner in which the initial set of educational modules is determined, the initial profile is used to determine an initial set of questions to be posed to the borrower. The initial set is selected from, for example, the questions store 108 shown in FIG. 1.

At operation 314, interactive display of explanations and educational modules is performed. The presented explanations and disclosures may include explanations about the NonQM loan, explanation that the process is oriented to make a determination regarding the ability of the borrower to repay the loan, explain to the borrower that the process will require a certain amount of time and should be completed without interruption, explain to the borrower that the process should be completed by himself/herself without intervening conversations with any loan officer associated with the loan, explain to the borrower that close approximations/rounding is acceptable, explain the importance of being truthful in providing the responses (e.g., disclose possible implications of committing fraud, and ramifications of foreclosure), etc.

One or both of the initial set of questions and the initial set of educational modules may be selected at least in part using sets of verification questions and/or educational modules that were previously associated with certain types of borrower profiles. For example, based upon how closely the current borrower's online profile matches the profile of a previous borrower, one or more verification questions and/or educational modules used in the verification process of the previous borrower may be included for the current borrower. As noted above, the system may include monitoring previously verified loans to keep track of such post verification aspects as whether the loan resulted in a non-payment or other negative claim. Historical performance data for previously granted loans acquired through such tracking can be used to associate certain sets of questions and/or educational modules with corresponding types of borrower profiles. This provides an aspect of learning by which the system according to some embodiments can automatically improve its selection of verification questions and/or educational modules, such that, based upon their online profiles (e.g., similarity of the current borrower profile to a previous borrower profile), particular borrowers can be presented with questions/educational modules selected in order to reduce the likelihood of certain types of claims, such as ability to repay, steering, benefit to borrower, misrepresentation, etc.

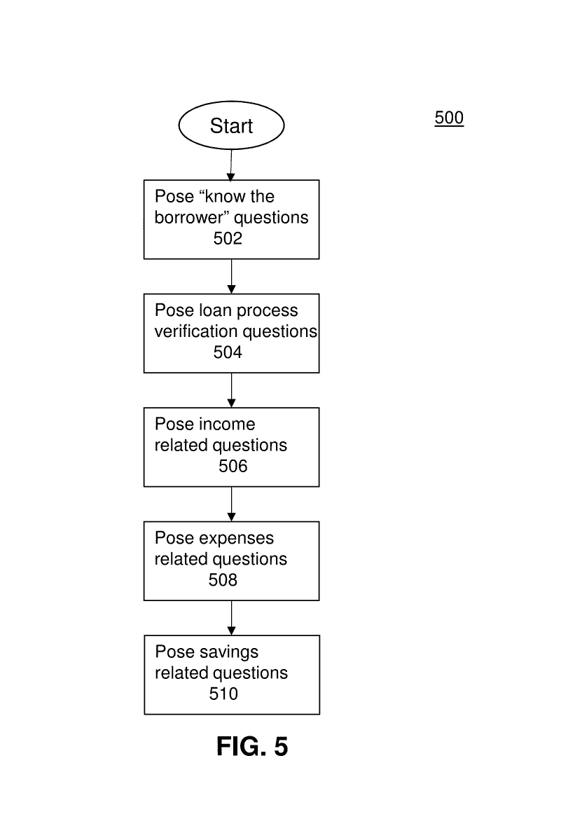

At operation 316, interactive and adaptive questioning of the borrower, and dynamic use educational modules is performed. The process of presenting verification questions is further described below in relation to FIGS. 5-9. The initial set of questions may be modified by adding questions thereto or removing questions therefrom as the questioning of the borrower progresses. For example, whereas the initial online profile for the borrower is generated based upon the information made available by the underwriter, some of the expense information may not have been taken into consideration in the initial online profile, resulting in the initial set of questions and the initial set of educational modules being selected based upon an incorrect estimate of the borrower expenses. However, when the borrower indicates, when responding in real-time to the series of verification questions, that he/she has an expense level that is substantially greater than (e.g., more than a predetermined percentage greater than) the initial estimate of expenses, the system may be configured to select and add additional questions and/or additional educational modules to the respective selected sets in order to assess a more detailed view of the borrower's expenses and/or to enhance the education provided to the borrower regarding the effect of high expenses on cash flow.

Thus, as the questioning progresses and the system collects corresponding responses from the borrower, the set of questions and the set of educational modules both may dynamically change in accordance with the responses so far provided by the borrower. For example, some questions may be associated with one or more stored rules, and responses to such questions may be heuristically evaluated against the one or more stored rules in order to determine the next question to be posed. Different questions may be selected, based upon the heuristic evaluation, as the next question to be posed. During the questioning, the online profile may also be modified to include any newly discovered information about the borrower.

The dynamic selection of the next question may be based upon receiving a response to the current question, and heuristically selecting the next question. The selection may be for asking more detailed questions regarding incomes/expenses, or asking a verification question providing for the borrower to respond with an answer that can be compared to underwriter provided information, so that a level of honesty of the borrower can be ascertained.

Dynamically selecting educational modules may be based upon, when a response is received as input from the borrower and it is determined that the response indicates a deficiency of knowledge about a subject (e.g., borrower input indicates a loan term that is different from that specified by the underwriter information), the system may adaptively add as appropriate one or more educational modules to the set of educational modules and then provide the module to the borrower. Similarly, when a received response indicates a potential deficiency in honesty, then an educational module regarding the importance of honesty in providing the requested information may be dynamically selected and provided to the borrower. As discussed above, certain questions/educational modules can be selected based upon previously configured associations of questions/educational modules with certain types of borrower profiles.

At operation 318, it is determined whether questioning of the borrower is completed. This determination may be based upon whether or not the selected (and adaptively modified) set of questions have been exhausted. In some embodiments, questioning may be determined to have completed when a predetermined proportion of questions has been responded to by the borrower.

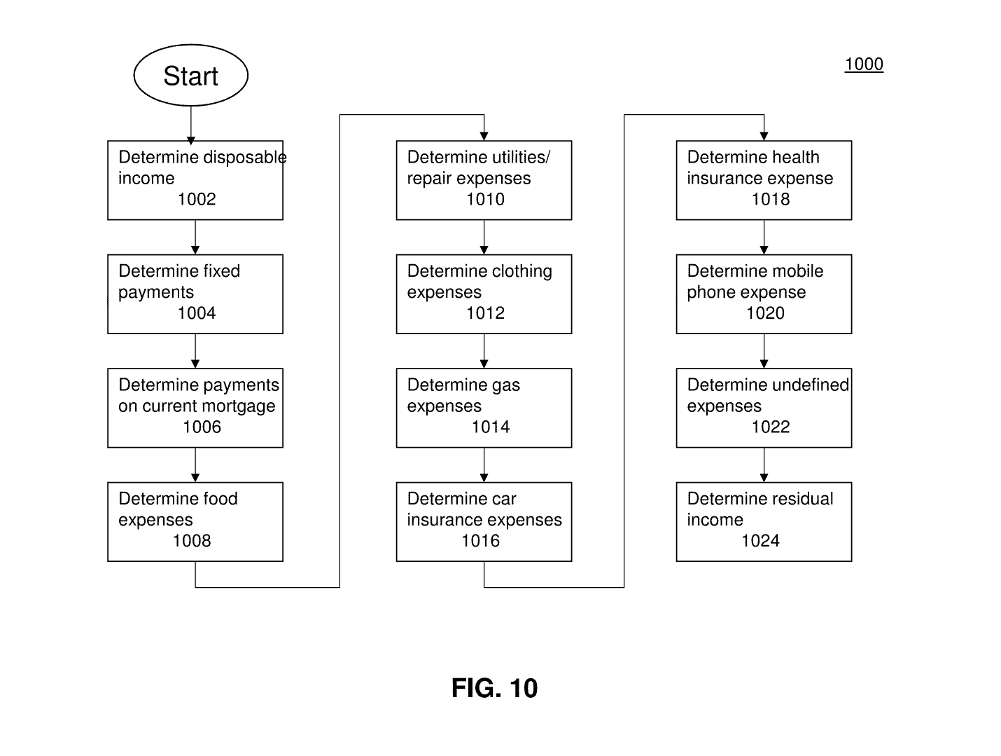

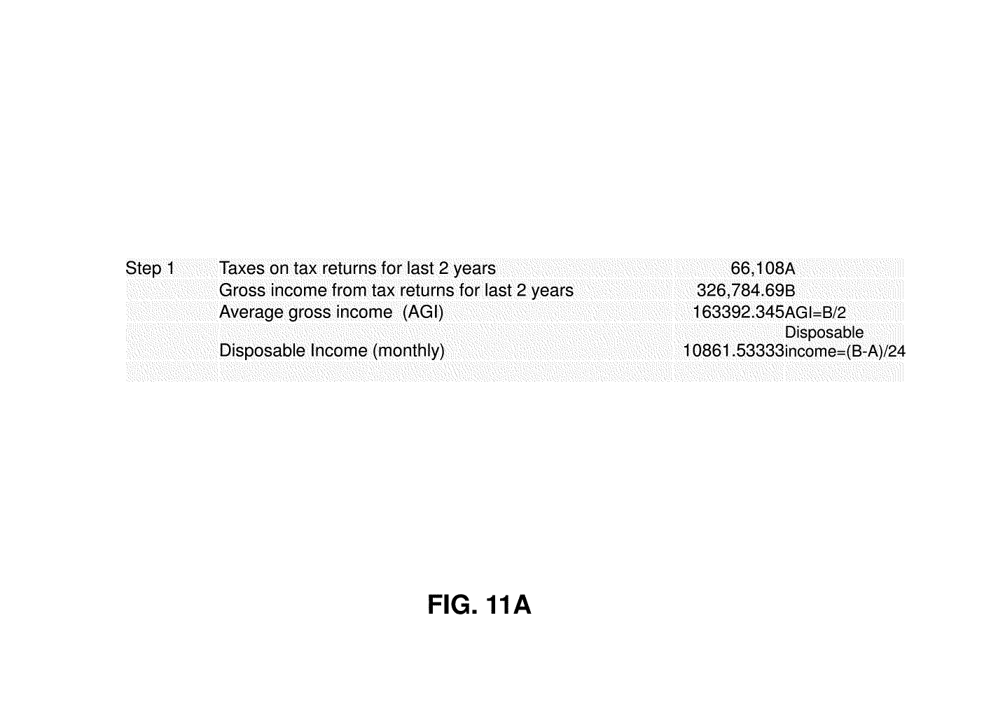

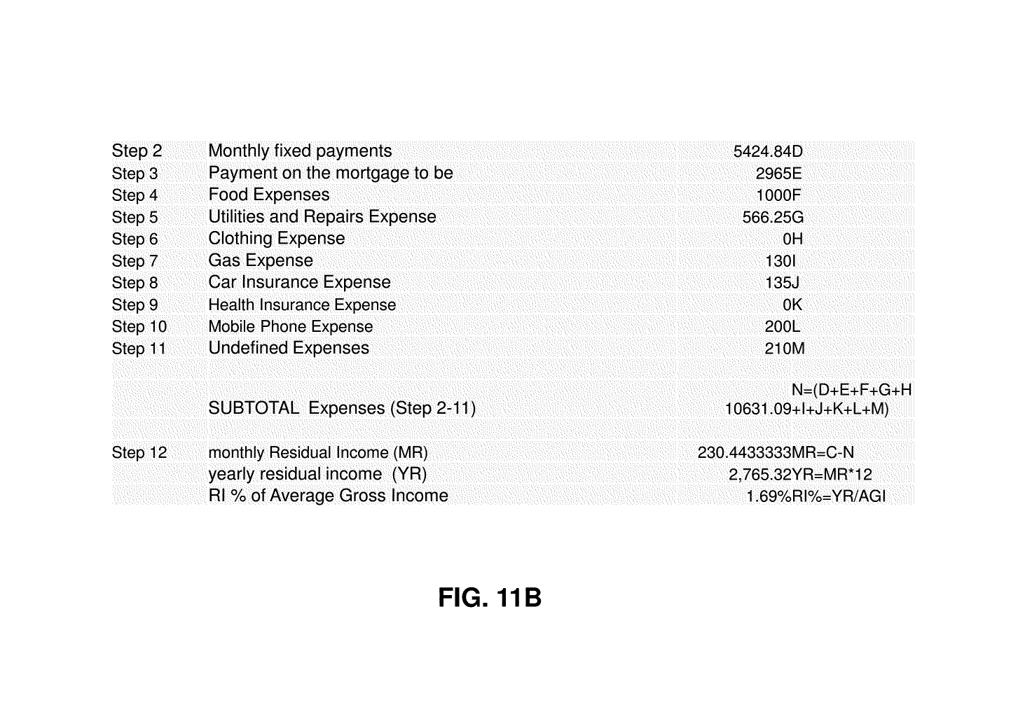

At operation 320, a disposable income amount is calculated. This calculation may be made automatically based upon available information from the underwriter and/or information already obtained from the borrower. In some other example embodiments, the borrower may interactively be asked to respond to questions necessary to determine the disposable income. The calculation of disposable income is described further in relation to FIGS. 10 and 11 below.

At operation 322, a residual income (RI) amount is calculated. The RI, which is based upon the average gross income and expenses, may be automatically determined using information from the underwriter and information already provided by the borrower. In certain embodiments, however, some of the expenses may be interactively determined. The calculation of the RI is described below in relation to FIGS. 10 and 11.

At operation 324, a RI to average gross income (AGI) ratio is determined.

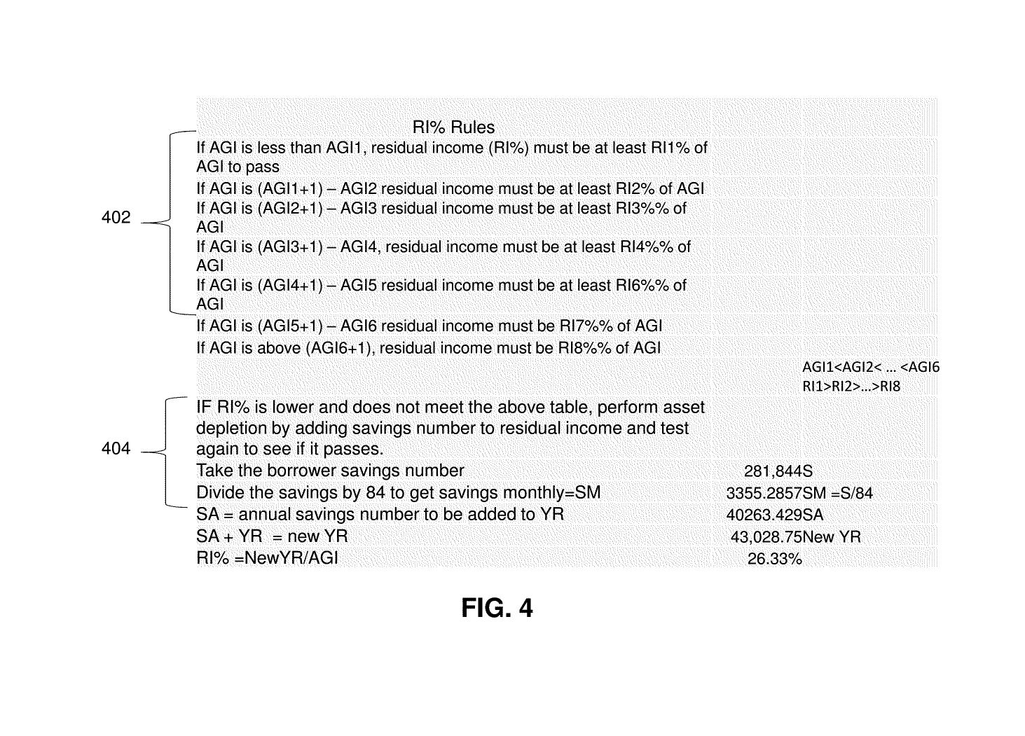

At operation 326, it is determined whether a predetermined threshold test is satisfied by the calculated RI/AGI ratio. The predetermined threshold test for RI/AGI is described below in relation to FIG. 4. As described in relation to FIG. 4, the test may be specified as a plurality of rules, each rule specifying a range of AGI and an associated RI.

At operation 328, if the test at operation 326 was not satisfied, an asset depletion process is performed and a new RI is determined. The asset depletion process is described below in relation to FIG. 4. After the asset depletion, a new RI is determined and processing returns to operation 326.

At operation 330, the borrower risk assessment is output. The risk assessment represents an estimation of the level of risk associated with the borrower's ability to repay the loan, and may be issued as pass or fail. If the risk assessment is passed, the subject loan, if a NonQM loan, may be considered as a NonQM verified loan, and the lender may choose to proceed with granting the loan having a record of a good faith dealing with the borrower. A certificate may be output providing verifiable proof of the good faith lending. Process 300 may be complete after operation 332. However, before the entire process 300 is terminated, the system may save a record of the transactions with the borrower.

FIG. 4 illustrates aspects of a residual income assessment formula in accordance with some example embodiments. As illustrated, a plurality of rules 402 relating RI with AGI is specified. For example, for each of a plurality of ranges of AGI, a corresponding RI is specified. In the example illustrated in FIGS. 3A-3B, if the AGI is less than $AGI1 (e.g., a predetermined dollar amount), then RI is required to be RI1% of AGI and, if RI is greater than $AGI6, then an RI to AGI percentage of RI8% is required in order to pass the test relating RI to AGI. As also shown, the range between AGI1-AGI6 is divided to sub-ranges and configured such that as the RI increases the required RI/AGI percentage is reduced. In the illustrated example, RI1>RI2>RI3>RI4>RI6 and AGI1<AGI2<AGI3<AGI4<AGI5<AGI6<AGI7<AGI8.

In some example embodiments, the ratio requirements may be changed in response to other factors determined during the process of presenting verification questions the borrower. For example, certain example embodiments may increase the ratio of RI/AGI required, as the number of questions for which the borrower's responses are inconsistent with the information received from the underwriter increases. Thus, the required ratios may be changed in certain embodiments, in accordance with a level of correspondence between the information provided by the underwriter and the information from the borrower.

Although the above example shows specific RI ranges and RI/AGI percentages, the ranges and the percentages are configurable. In certain example embodiments, the ranges and associated percentages are configured so that as the RI increases the required RI/AGI percentage is reduced.

FIG. 4 also illustrates an asset depletion and RI re-calculation formula 404, according to some embodiments. The asset depletion operation is to be performed when the RI/AGI does not satisfy the threshold in the first run.

Asset depletion may be performed by, taking the borrower's savings amount (or, in some embodiments, the sum of savings and investments), and dividing by a predetermined number to determine a divided savings number. In the illustrated example, the divisor is 84, and the divided savings number is referred to as the savings monthly. According to an example embodiment, the divided savings number may be a portion of the total savings that can be attributed to each month over a period of time. For example, if the total savings are to be depleted over seven years, then dividing by the divisor 84 will find the savings amount attributable to a month.

Thereafter, a yearly savings amount is determined. For example, the monthly savings amount may be multiplied by 12 to determine the yearly savings amount. In effect, this amount is the portion of the savings that is attributable to a year.

Then, a new residual income is determined by adding the determined yearly savings amount to the current residual income. Thereafter, the RI/AGI test is performed using the newly determined RI.

FIG. 5 illustrates a process 500 for posing automatically selected and/or generated questions according to certain example embodiments.

After entering process 500, at operation 502, one or more questions of the type “know the borrower” are presented to the borrower. For example, throughout process 500, the questions may be presented to the borrower on a display of the borrower terminal 104. The borrower's response may also be provided through an input device associated with the borrower terminal 104.

The reasons for which the borrower is requesting the loan may be queried. Questions posed may include queries as to whether the loan is for a purchase or a refinance. If the loan is for a purchase, the system may determine whether this is a first home for the borrower. If this is not a first home, then it may be beneficial to query reasons for moving, number of years at the last home, and whether borrower owned last home. If the borrower does not own the last home, the reason for renting may be obtained. The borrower provided inputs may be in the form of checkboxes or Boolean-type responses, numeric responses, or text fields. If the borrower indicated that the loan is for a refinance, then questions may be posed as to whether the owed amount would be greater after the refinancing and, if so, for what purpose the equity is being taken out. If the borrower indicates that the new loan terms are not better for him/her, the system may flag the application for manual review.

Questions may also be posed as to whether the borrower had previous mortgages, the number of times mortgages were applied for, and other information about such previous mortgages.

Other questions in this category of questions may include whether any life changes are expected in the next 5 (or some other duration) years and, if yes, requesting information on the expected life changed; whether any major expenditures (e.g., greater than $5,000) planned for the next 12 months (or other duration) and, if yes, requesting information regarding the amount and description of the expense; total amounts in savings, investment, checking or retirement accounts (such as, for example, retirement accounts not maintained by employer); and whether the borrower's income changed over the last 3 years (or other duration) and, if yes, asking whether the it has decreased or increased.

The questions regarding change of income may be posed as to determine whether there any changes to the income on a monthly basis over the last predetermined number of years. For any increases, the reason and amount of increase may be determined. Likewise, for each decrease, the amount and reason may be determined. Moreover, if an increase is determined up to the current point, the borrower may be queried as to whether the increase should be considered permanent. If a decrease is noted up to the current time, either the borrower may be queried as to whether it should be considered a permanent decrease, or the system may itself determine to treat it as a permanent decrease.

The borrower may also be queried as to whether any changes to income is expected for a predetermined period in the future (e.g., the next 5 years). If yes, further questions may be posed for the reason for the change, whether an increase or decrease and, if it is a decrease, seek to determine the amount by which the income is to decrease. By selectively determining the magnitude of the expected decrease, the system can take this information into account when considering potential risks due to changes from current situation.

Questions may also include whether the current transaction would increase or decrease the current mortgage of the borrower and, if it increases, to determine the amount by which it increases.

Further questions may be directed to changes in spending habits over the last 3 years (or other duration). If spending has increased, the system may seek to determine by how much, the reasons for the increased spending, and the duration of the increased spending. If spending has decreased, the system may seek to determine by how much, the reasons for the decreased spending, and the duration of the decreased spending.

The borrower may be queried as to whether the monthly cost of the rent or mortgage remained substantially the same over the last 3 years and, if yes, as to for how long it has remained the same. Otherwise, it may be determined whether the rent or mortgage increased or decreased.

The borrower may be queried as to expectations of a job or career change in the next 2 years (or other duration) and any associated income increase/decrease; the number of different employers in the last 5 years (or other duration); whether in the last 12 months (or other duration) the borrower was subject to job demotion, pay cut, formal discipline by employer, or a complaint regarding job performance or conduct on the job; whether the employer has had any layoffs in the last 12 months; and whether any competitor of the employer had layoffs in the last 12 months. If the borrower indicates that the employers has had layoffs or that he has been subjected to a complaint, the application may be flagged for manual review.

The borrower may also be queried regarding the highest grade of education completed. For example, the borrower may select from the options 12^{th} grade, some college or trade school, college, or post college degree. Other categorical groupings may be used in different example embodiments.

Still further, the borrower may be queried to determine whether he/she has been convicted of a crime, and to determine whether he/she has been required to personally pay a judgment. A dropdown menu or the like may be provided for the borrower to indicate the type of judgment, e.g., fraud, theft, failure to pay rent, embezzlement, misrepresentation, theft, breach of fiduciary duty, etc. The borrower may also be queries as to whether he/she has been convicted or pleaded guilty or no contest to criminal charges. A dropdown menu or the like may enable the borrower to select from fraud, embezzlement, extortion, theft, perjury, forgery, counter fitting, tax evasion, money laundering, etc.

At operation 504, one or more questions of the type loan process verification are presented. Explanations may be provided of loan terms such as, for example, duration, whether the interest rate is fixed or adjustable. If the rate is fixed, the borrower may be queried to specify the fixed rate. If adjustable, the borrower may be queried as to when the rate adjusts, the highest possible rate, how new interest rate is determined upon adjustment, and what the maximum possible payment could be. If the borrower's responses are not consistent with the loan terms, then the application may be flagged for manual review.

Questions in this category may also include purpose for obtaining the loan, whether various options were discussed and/or considered, determination of the borrower's understanding of the loan terms, borrower's rationale for selecting this loan, and promises or representations, if any, by loan officer that were important in the borrowers decision to proceed.

Regarding various loan options, the borrower may be questioned as to whether he/she was advised regarding the different options for financing the property. If the borrower responds in the negative, further questions may be directed to determining whether the borrower was specifically told that the present option was the only option available for the circumstances. If the borrower responded in the affirmative, then questions may be posed regarding the options considered and the reasons as to why the present selection of loan was made. A dropdown menu or the like may be provided so that the borrower may select, for example, from lowest upfront cost, lowest payment, lowest interest rate, etc.

At operation 506, one or more questions of the type income-related questions are presented. Questions to be posed in this category may include queries as to net take home pay per month, net amount of bonus, and net annual income from other source. The borrower's tax characteristics may also be queried. For example, a dropdown menu or the like may be provided for the borrower to indicate whether he paid no taxes, owed taxes, or received refund. If it is indicated that taxes were owed, an amount can be determined. If it is indicated that the borrower still owes taxes, the application may be flagged for manual review.

At operation 508, one or more questions of the type expenses-related questions are presented. Expense-related questions may be posed to determine amounts and types of expenses for utilities, insurance, medical, groceries, entertainment, credit card payments, loan or debt payments, tax obligations, car-related payments (e.g., car payment, insurance, fuel, repairs), clothing, travel, child care, gifts, tuition, child support, rent/mortgage, and/or monthly loss of rental properties/investments.

At operation 510, one or more questions of the type savings-related questions are presented. Savings-related questions may include contributions or deductions to savings, retirement or investment accounts in last 36 months from net pay, total amount in savings, investments retirement accounts and/or checking from three years ago and from one year ago.

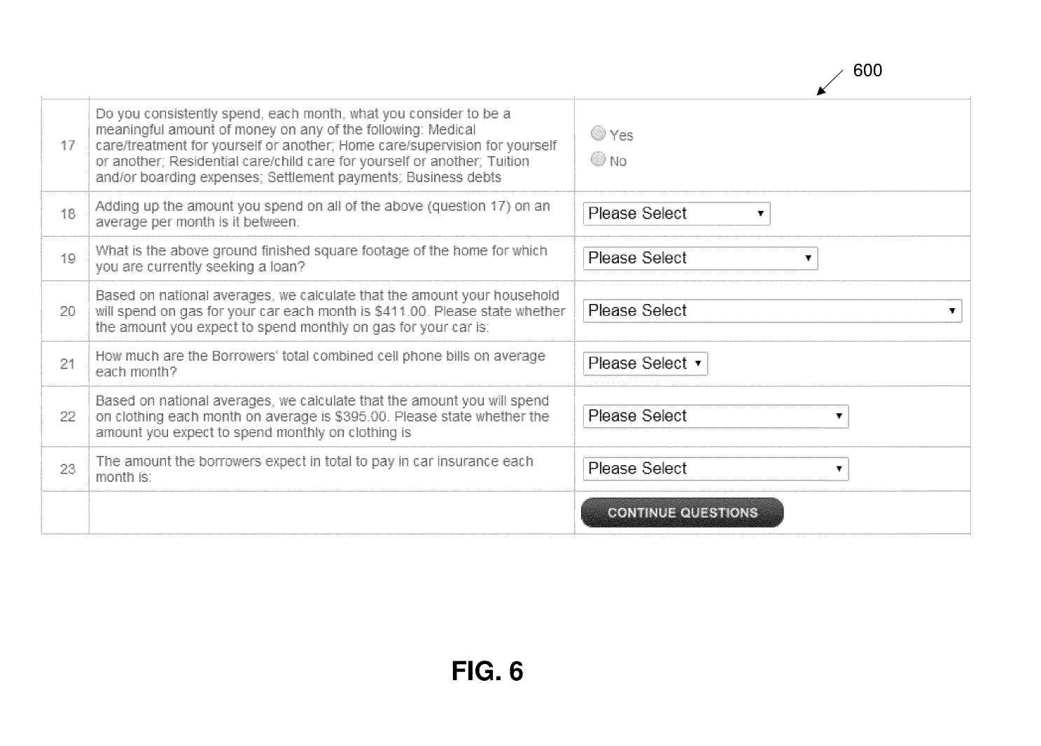

FIG. 6 illustrates an example display screen 600 for posing borrower questions according to certain example embodiments. These questions may propose a budget for the borrower based on gross income (and borrower is enabled to confirm the algorithm's conclusions). For example, as shown in questions 20 and 22 shown in FIG. 6, the system may determine a likely amount which the borrower may spend on certain expenses, and ask the borrower to either confirm or correct such automatically determined amounts. As also can be noticed in FIG. 6, embodiments may use radio buttons, dropdown menus, and the like to make data input by the borrower more convenient for the borrower, and more accurate.

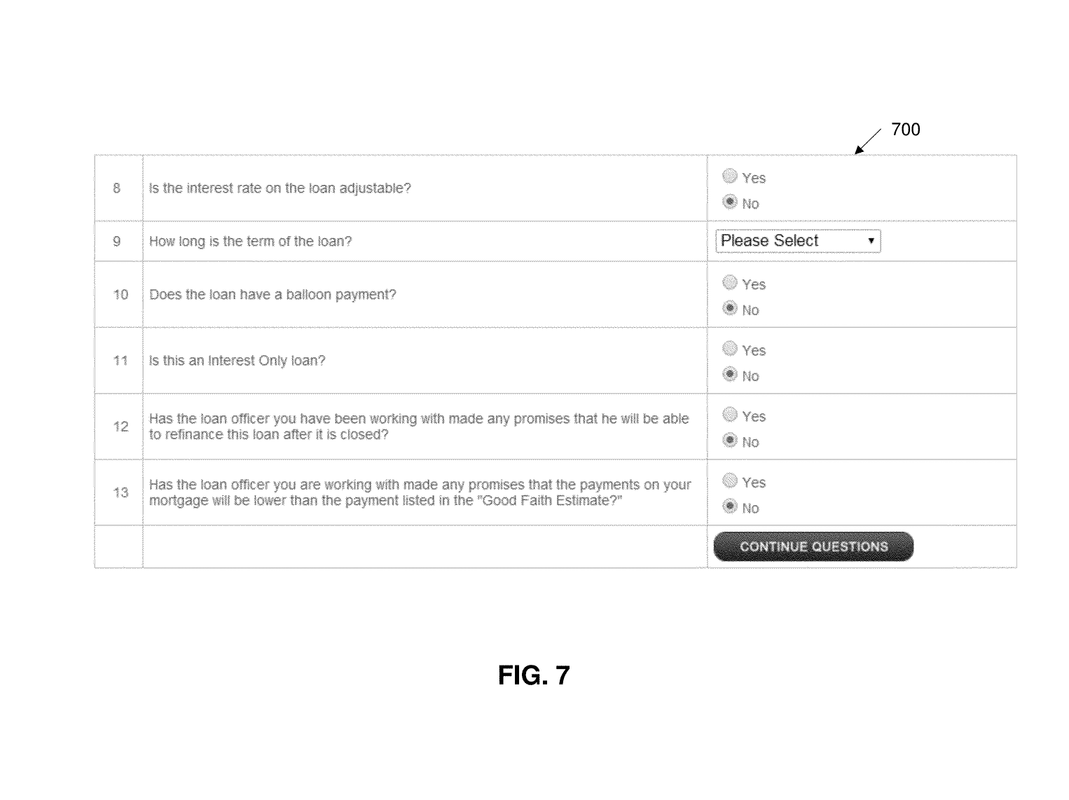

FIG. 7 illustrates an example display screen 700 for posing loan process verification questions according to certain example embodiments. These questions can be used in embodiments to address commonly alleged material misrepresentations and reduce or eliminate their occurrence in the loan. For example, questions 8-11 shown in FIG. 7 are directed to obtaining the borrower's understanding of loan terms. Questions 12-13, also shown in FIG. 7, are directed to determining whether there is a possibility of a misrepresentation having been made by the loan officer.

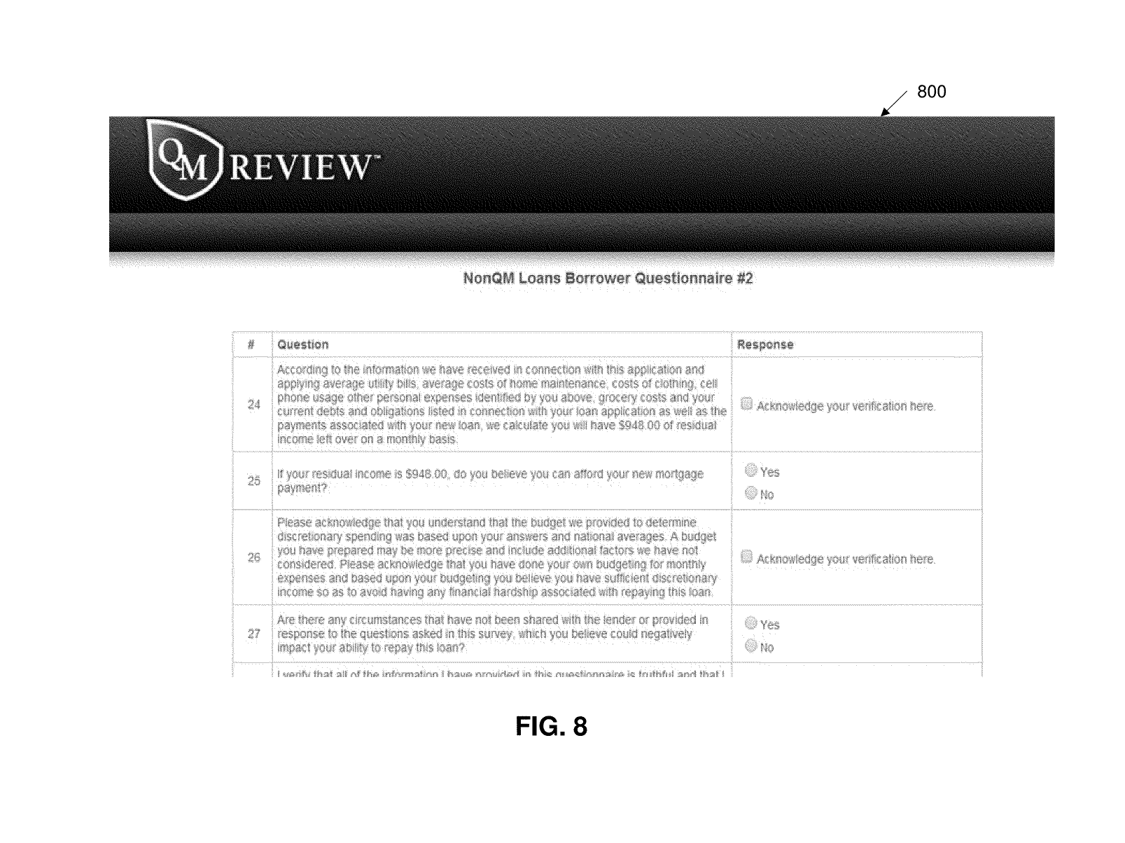

FIG. 8 illustrates an example display screen 800 for posing income-related questions according to certain example embodiments. Borrowers can personally confirm the algorithm's conclusions regarding the ability to repay. For example, the system, based upon information available to it, calculates a residual income and, as shown in question 24 in FIG. 8, requests the borrower to confirm its determination.

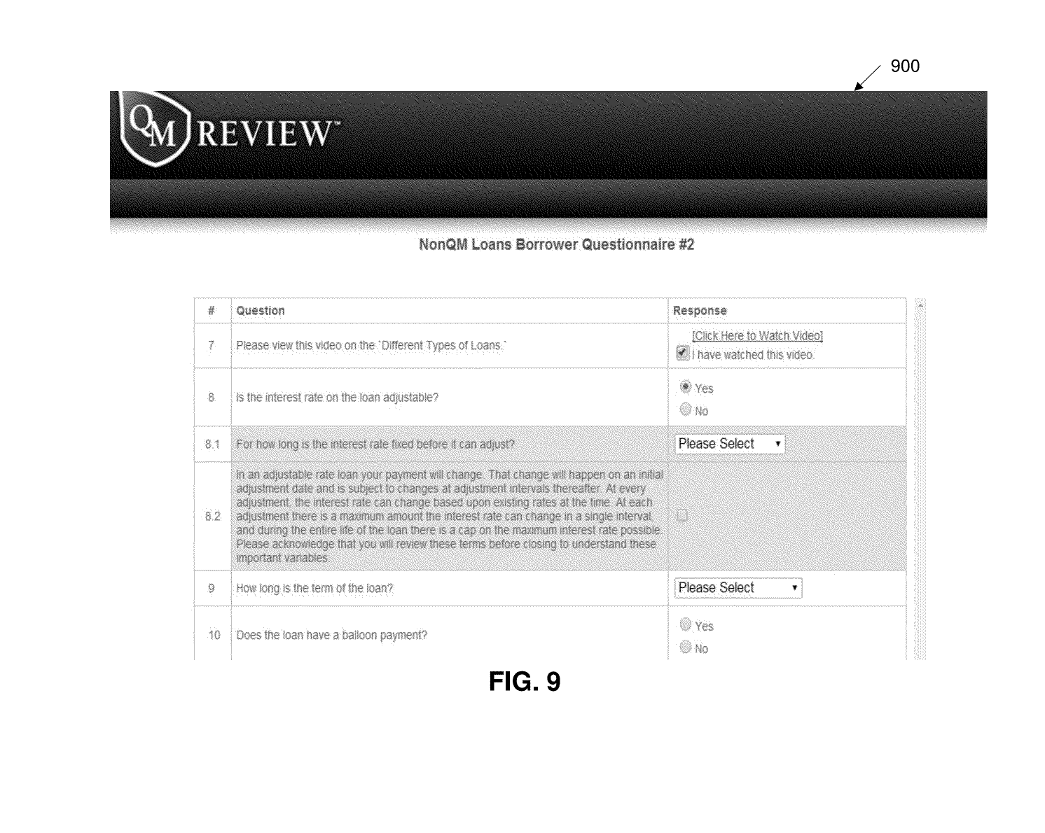

FIG. 9 illustrates an example display screen 900 for posing loan terms related questions according to certain example embodiments. The answers received can be matched against the actual loan ensuring the borrower understands their loan.

Screen 900 illustrates one manner in which the borrower can be provided with access to educational modules. For example, item 7 in FIG. 9, the borrower is provided with a link to a video educational module. If the borrower does not want to watch the video, he/she may be required to acknowledge that he/she has watched the video. In order to ensure that the good faith attempt to educate borrowers can be better established, the system may not let the borrower proceed to the next question until he/she has either used (i.e., watched, read, listened to) the educational module or has acknowledged his familiarity with the subject matter by checking an input box, or the like.

FIG. 10 illustrates a flowchart for a process 1000 for computing the residual income according to certain example embodiments.

After entering process 1000, at operation 1002, gross income is determined. The gross income may be determined from the information provided by the underwriter. An average gross income (AGI) may be determined by determining the average of two or more years' gross income.

At operation 1004, fixed payments are determined. This amount can be determined from the underwriter provided information.

At operation 1006, payments on current mortgage are determined. This amount can be determined from the underwriter provided information.

At operation 1008, food expenses are determined. A budget amount for food expenses can be determined based upon a national average and the number of persons in the borrower's household. The number of persons in the household may be determined either by querying the borrower, or from the underwriter provided information. For example, the number of dependents are provided in the borrower's tax return, and therefore is available to the underwriter to provide as underwriter provided information to the borrow risk calculation system.

At operation 1010 utility and repair expenses are determined. A budget amount may be based upon a national average household utility and repair expense or as an amount in proportion to the square footage of the borrower's residence. The size of the residence can be queried from the borrower. The borrower can be permitted to either accept or modify the proposed budget.

At operation 1012, clothing expenses are determined. A budget amount may be based upon a national average clothing expense or as a predetermined fraction of gross income. The borrower can be permitted to either accept or modify the proposed budget.

At operation 1014, gas expenses are determined. A budget amount may be based upon a national average household gas expense or as a predetermined fraction of gross income. The borrower can be permitted to either accept or modify the proposed budget.

At operation 1016, car insurance expenses are determined. A budget amount based upon a national average may be presented to the borrower. The borrower can be permitted to either accept or modify the proposed budget.

At operation 1018, health insurance expenses are determined. A budget amount based upon a national average may be presented to the borrower. The borrower can be permitted to either accept or modify the proposed budget.

At operation 1020, mobile phone expenses are determined. A budget amount based upon a national average may be presented to the borrower. The borrower can be permitted to either accept or modify the proposed budget.

At operation 1022 undefined expense are determined. Undefined expenses may include any expense, not identified above, that the borrower considers that he/she is under an obligation to pay. The borrower may be requested for this input. In some embodiments, a predetermined fraction of one or more other expenses can be used for undefined expenses. For example, by default, a configurable fraction (e.g., 1%) of the average AGI may be considered as an estimate of the total annual undefined expenses.

At operation 1024, the residual income (RI) is determined. According to certain example embodiments, a monthly disposable income amount is determined by subtracting the average annual tax from the AGI, per month. The monthly residual income is then, the monthly disposable income minus the sum of monthly expenses (per operations 1004-1022). From the monthly residual income, an annual residual income (RI) is determined. Thereafter, a proportion of RI to AGI is determined.

FIGS. 11A and 11B illustrate an example spreadsheet for determining the residual income, according to certain example embodiments. The spreadsheet represents an example of the calculations performed by process 1000 described above.

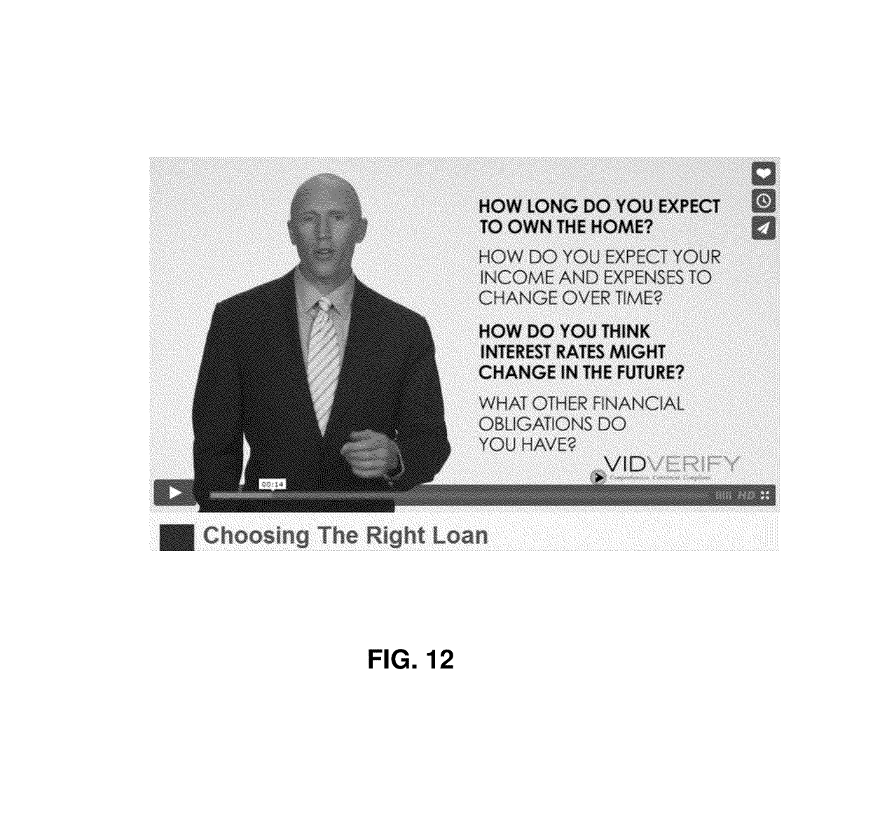

FIG. 12 illustrates an exemplary screen 1200 displayed by an educational module according to certain example embodiments. Screen 1200 is an example of how explanations about certain questions to be posed during the verification process may be presented to the borrower. For example, the illustrated instance of the screen may be displayed while the audio portion of the educational module proceeds to present explanations regarding duration of home ownership, expectations regarding changes to income or expenses, understanding of changes in the interest rates, etc.

In certain example embodiments, questions and/or educational modules to be dynamically selected and presented may be based on, for example, low test scores, the collection of inconsistent data across multiple uses and/or directly submitted borrower data that is inconsistent with data collected from a previously-submitted application, the amount of time it takes to answer questions and/or view a module, etc.

As described above, the example embodiments provide for reducing the risks associated with NonMQ lending. In some example embodiments, a third party verification system is implemented which can provide a good faith evaluation of the borrower's ability to repay the loan. By providing a technique by which the associated litigation risk is reduced, embodiments may provide for rapid growth in the NonMQ loan market.

It will be appreciated that as used herein, the terms system, subsystem, service, programmed logic circuitry, and the like may be implemented as any suitable combination of software, hardware, firmware, and/or the like. It also will be appreciated that the storage locations herein may be any suitable combination of disk drive devices, non-volatile or volatile memory locations, solid state drives, CD-ROMs, DVDs, tape backups, storage area network (SAN) systems, and/or any other appropriate tangible computer readable storage medium. It also will be appreciated that the techniques described herein may be accomplished by having a processor (e.g., central processing unit (CPU) or specialized processor) execute instructions that may be tangibly stored on a computer readable storage medium. In this regard, the system for verifying a borrower's ability to repay a loan, and/or its component subsystems such as the borrower risk assessor 102, terminal 104, video/audio educational module library 106, question store 108, and interface 110 may be performed (e.g., executed from binary code or interpreted from a higher-level language) in connection with a computer system including at least one processor and a memory, and the program code structures disclosed herein may be executed on the same computer systems and/or different computer systems that are operably connected to and able to gather information from those computer systems. Cloud-based storage and/or execution also is included.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

The following, appearing before the claims of this application, are some example questionnaires that can be used in example embodiments.

### APPENDIX

### Example Verification Questions

Example Question Flow

What is the reason for this loan?

Drop down menu (Purchase or Refinance)

If Purchase
Are you a first time home buyer?
1. If no:
   1. Why are you moving?
   2. Did you own the last home you lived in?
   3. If no:
      a. When was the last year in which you owned a home
      b. Why were you renting
   2. Will buying this house result in a mortgage that is more than your current rent/mortgage?
      1. If yes, how much will the increase be in comparison to your current rent/mortgage? (Drop down menu 1-250; 250-500; 500-750; 750-1000; 1000-1500; above 1500)

If a Refinance
1. Will you owe more on this home after the refinance
   1. If yes, what is purpose of taking out equity (drop down menu: pay other debt, renovation, investment, tuition, other (text answer))
      a. Are terms of new loan better for you than under the existing mortgage?
   2. If no and they are not going to owe more, this application is flagged for manual review

Have you applied for a mortgage on the same property which is the subject of this application in the past 6 months?

If yes:
1. Was the loan application (Dropdown menu: Approved, denied, withdrawn)

Have you applied for mortgages on any other properties in the last 6 months?

In the last 12 months have you been late or required assistance from others to pay your mortgage?

How long have you had the current mortgage you are attempting to refinance?

How did you learn of this lender (Dropdown menu: referral from realtor, referral from friend, referral from builder, referral from other, advertisement, telemarketing, internet, other)

Has your current lender (check y/n for each box)
Explained the terms of the loan you are applying for
Explained why you needed to get a non-qualified mortgage
Explained the difference between a qualified and non-qualified mortgage
Discussed other loan scenarios/options with you or advised you there were no other options
Explained why he or she believes this is the best option for you
(If any box is checked no, trigger manual review)

Please identify all of the features of the loan you are applying for:
Is the interest rate fixed for the life of the loan or is it adjustable (dropdown menu)
If Adjustable rate:
   1. What is the maximum interest rate under the loan?
   2. What is the minimum interest rate under the loan?
   3. On what date can the loan adjust?
   4. What is the maximum payment under the loan?
   5. How long is the term of the loan?
   6. Is there a penalty for pre-payment?
   7. Is there a balloon payment?
      1. If yes:
         a. How much is the balloon payment?
         b. When is it due?
         c. Is this a loan where you are only required to pay the interest?
         i. If yes:
         ii. Do you ever have to start paying back the principle?
         ii. If yes, when
         iii. How long do you have to pay back the full amount of the principle?
         iv. What will your payment be when you must begin repaying principle?

Has the loan officer you are working with made any promises about the loan or what will happen after the loan is closed that are different from or in addition to the loan terms you outlined above?

Did you speak to any other lender concerning this loan?

If yes:
1. Did you discuss loan options with another lender? (Y/N)

Why did you ultimately select your current lender? Dropdown menu (better loan terms, better service, buying incentive, other)

In the last 12 months:
Have you experience a significant change in your monthly income?
   1. If yes:
      1. Was this an (dropdown increase or decrease)
      2. Do you expect this change in income to be (dropdown short term, long term don't know)
      3. If increase and short term are selected, flag for manual review
Have you experienced a noticeable change in your monthly financial obligations?
   1. If yes:
      1. Was it an increase/decrease in your monthly obligations (dropdown menu)?
      2. Do you expect this change is (dropdown menu: short term, long term, don't know)
Have you incurred any expenses that were not a normal monthly expense and that were unexpected and required you to utilize amounts in your savings that you consider significant
   1. For which you had been saving money anticipating such a purchase/expense
   2. If the answer to either is yes:
      1. What is the amount in total spent in the last 12 months on these items?

In the upcoming 12 months do you expect:

Any significant change to your income
1. If yes:
   1. Do you expect your monthly income to increase or decrease (dropdown)
   2. Do you expect this to be a change that is (Drop down menu: short term, long term, or don't know)
   3. If decreasing, select reason for decrease (Drop down menu: career change, retirement, moving, job change, work less)
      a. By how much would the monthly income decrease (drop down menu: 1250; 250-500; 500-1000; 1000-1500; will decrease more than 1500)

Any significant change to your monthly financial obligations
1. Do you expect your monthly obligations to increase or decrease (dropdown)
2. Do you expect this to be a change that is (short term, long term, or don't know)

If this loan application is approved will it increase your current rent/mortgage payment

If yes:
1. How much do you expect your rent/mortgage to increase as a result of getting this loan?

If no:
1. How long has your rent/mortgage been at its current amount?
2. What is the total amount currently in any savings, investment, checking or retirement accounts (not maintained by your employer)?

Are you able on a regular basis (most months) to contribute any money?
To retirement accounts maintained through your employer
To any personal savings, investment or other type of retirement account (other than one maintained by your employer)

Adding up all your checking, savings, and/or investment accounts not maintained by your employer, is the balance of those accounts today (higher, lower, the same), as it was 12 months ago
If higher/lower is selected: please approximate the difference in the balance of those accounts in aggregate

Adding up the balances of any outstanding credit cards, loans, or other debts today, is the balance of those accounts today (higher, lower, the same), as it was 12 months ago?
If higher/lower is selected: please approximate the difference in the balance of those accounts in aggregate

Do you expect to change your job or career in next 2 years

If yes:
1. Do you expect your income to decrease as a result of that change?
   1. If yes, how much?

In the last 12 months, have you been the subject of
a job demotion
a pay cut
formal discipline by your employer
a complaint against you concerning job performance or conduct on the job
a lay-off
Has your employer had any lay-offs of which you are aware in the last 12 months?
What is the amount of your net take home pay per month?
In addition to this do you get bonuses or other compensation annually or quarterly?
If yes, list frequency and average amount (need a drop down for quarterly/annually option) and text for them to insert average amount.
Please list any other sources of income you receive in terms of net dollars received after taxes or other withholdings.

When you file your tax returns, do you usually (dropdown pay nothing, owe taxes, receive refund).
What was the amount of money you received/paid to the government in taxes in the last year?
Do you currently owe taxes to any governmental authority?
   1. If yes, how much

(The program may compute net monthly income taking into all sources, taking into account increase or subtraction from taxes, and dividing by 12 to get monthly average income)

Please list all current amounts for monthly expenses on an average:

Utilities/Insurance

Medical expenses

Groceries Entertainment

Credit card payments

Other loan/debt payments

Tax obligations

Car (payment, insurance, fuel, repairs)

Clothing

Travel

Child care

Gifts

Tuition

Child Support

Rent/mortgage

Monthly loss of rental properties/investments

Next screen shows same list of expenses and ask borrower as follows:
Below are the amounts you listed as your current expenses. If you expect any of those numbers to change significantly as a result of upcoming obligations or changes in lifestyle in the next 12 months, please change those expenses accordingly. If you do not expect any changes, please simply select no change and continue.

Adding up the amount you spend on all of the above (monthly expenses listed above) on average per month is it between (dropdown menu: numbers calculated at brackets derived from applying following percentages to disposable Income, using actual numbers in plate of following percentages 0-20%; 20-40%; −4060%; 6080%; 80-100; above 100%)

Do you own a vehicle? (yes/no)

According to the information we have received in connection with this application ad applying average utility bills, gas consumption, car insurance, grocery costs and your current debts as well as the payments associated with your new load, you will have [calculated amount based upon disposable income and total monthly expenses (subtract further amount if borrower owns vehicle)] of disposable income on a monthly basis. Please acknowledge that you understand that in order to make all your payments without tapping into savings every month, you will need to confine all discretionary spending to [calculated amount].

Is [calculated amount] sufficient on an average basis to cover your total monthly discretionary spending (provide link to definition/educational module)? Before answering you should click on the links to the definitions of essential and discretionary spending.

End of borrower questions.

### APPENDIX

### Information from the Underwriter

The following is an example list of questions for the underwriter, on which the underwriter supplied information may be based.

1. Loan Number

2. Amount of payment including PMI, insurance

3. Amount of all other fixed credit monthly payments as listed on/verified from 1003

4. Total monthly obligations computed by adding lines 2 and 3

5. Zip code of property

6, Amount of Gross Income on Tax returns last 2 years

7. Amount of taxes owed on income the last 2 years

8. Number of dependents as listed on tax returns plus borrower and spouse

9. Compute average net income monthly by subtracting line 7 from line 6 and dividing by 24

10. Multiply 150 times line 8

11. Add lines 4, 10, plus 250,

12. Compute Disposable Income by subtracting lines 11 from line 9

13. Have all typical underwriter processes been followed in connection with load (yes/no)

14. Have there been any exceptions to underwriting criteria made in connection with loan (yes/no)

15. Have all assets, liabilities and income been verified with and are supported by documentation (yes/no)

16. Is there anything to suggest that borrower's information is inaccurate and/or that the borrower lacks the ability to repay the loan (yes/no)

17. Type of loan: term, rate, features, etc.

18. Total amount in savings/investments

19. Does borrower have 90 days reserves

What is claimed is:

1. A system for verifying a borrower's ability to repay a loan, the system comprising processing resources including memory and at least one processor, the processing resources being configured to control the system to perform operations comprising:
receiving first information related to the borrower;
determining, based at least in part on the received first information, a set of educational modules and a set of verification questions;
collecting second information related to the borrower based upon responses provided by the borrower in real-time to a series of questions presented, wherein questions for the series are determined from the set of verification questions dynamically based upon the first information and said responses so far collected, and wherein during the collecting the borrower is provided access to one or more educational modules in the set of educational modules selectively based upon the first information and said responses so far collected;
determining, based upon the first information and the second information, a ratio of a residual income to an average gross income for the borrower;
evaluating the ratio based upon a predetermined set of rules associating average gross incomes and residual incomes;
determining, based upon the evaluating, a risk status associated with the borrower's ability to repay the loan; and
producing an output based upon the determined risk status.

2. The system according to claim 1, wherein the predetermined set of rules represents plural pairs of average gross income and corresponding ratios of residual income to average gross income such that higher average gross incomes are associated with lower ratio requirements.

3. The system according to claim 1, the evaluating comprises, in response to the determined average gross income and the ratio of residual income to average gross income failing to satisfy the predetermined rules, calculating a new residual income after supplementing the residual income with a portion of savings, and performing the evaluating again with the determined average gross income and the new residual income.

4. The system according to claim 1, wherein the determined risk status is further based further upon a level of correspondence between the first information and the second information.

5. The system according to claim 1, wherein the average gross income is determined by subtracting taxes paid from reported income for one or more past years, and wherein the residual income is determined by adjusting the average gross income based at least upon monthly fixed expenses, mortgage payments, food expenses, utilities expenses, clothing expenses, gas expenses, car insurance expenses, health insurance expenses, and mobile phone expenses.

6. The system according to claim 1, further comprising recording, in a non-volatile memory and in association with at least some of the first information, the output, the collected second information, the series of dynamically determined questions, and information related to the one or more educational modules to which said access was provided.

7. The system according to claim 6, further comprising recording in the non-volatile memory responses provided by the borrower while engaging with the one or more educational modules.

8. The system according to claim 6, wherein the recording includes recording audio and/or video of the borrower.

9. The system according to claim 1, wherein questions in said series are heuristically determined based upon the first information and said responses so far collected.

10. The system according to claim 9, wherein heuristically determining a question includes applying one or more predetermined rules to at least one of said responses so far collected.

11. The system according to claim 1, wherein at least one question in the series is adaptively selected to test a level of honesty of the borrower based upon a received response.

12. The system according to claim 1, wherein the series is a subset of the determined set of verification questions.

13. The system according to claim 1, wherein selectively providing access to one or more of the educational modules comprises determining, based upon at least one of the received responses, a deficiency of knowledge on the part of the borrower about a subject and, in response to the detecting, selecting one of the educational modules corresponding to the subject.

14. The system according to claim 13, wherein the determining includes applying one or more predetermined rules to said at least one of the responses.

15. The system according to claim 1, wherein selectively providing access to one or more of the educational modules comprises determining, based upon at least one of the received responses, a potential deficiency in honesty on the part of the borrower, and, in response to the detecting, selecting one of the educational modules corresponding to the subject.

16. The system according to claim 1, wherein said one or more educational modules is a subset of the determined set of educational modules.

17. The system according to claim 1, wherein the operations further comprise:
generating an online profile of the borrower based upon the first information; and
determining the set of educational modules and the set of verification questions based at least upon the online profile.

18. The system according to claim 17, wherein the operations further comprise
modifying the online profile using at least a real-time web operation; and
verifying at least one item in the first information or the second information based upon the modified online profile.

19. The system according to claim 17, wherein the operations further comprise:
modifying the online profile using at least one of a real-time web operation or one of said responses so far collected; and
selecting, based upon the modified online profile, at least one question for the series.

20. The system according to claim 1, wherein the first information is electronically received from an external computer system and comprises information previously supplied by the borrower to an underwriter of the loan.

21. The system according to claim 1, wherein determining the initial set of educational modules comprises selecting a subset of educational modules from a predetermined set of educational modules based upon the first information, and wherein determining the initial set of questions comprises selecting a subset of questions from a predetermined set of questions based upon the first information.

22. A method for verifying a borrower's ability to repay a loan, the method comprising:
using processing resources including at least one processor and a memory operably coupled thereto,
receiving first information related to the borrower;
determining, based on the received first information, a set of educational modules and a set of verification questions;
collecting second information related to the borrower based upon responses provided by the borrower in real-time to a series of questions presented, wherein questions for the series are determined from the set of verification questions dynamically based upon the first information and said responses so far collected, and wherein during the collecting the borrower is provided access to one or more educational modules in the set of educational modules selectively based upon the first information and said responses so far collected;
determining, based upon the first information and the second information, a ratio of a residual income to an average gross income for the borrower;
evaluating the ratio based upon a predetermined set of rules associating average gross incomes and residual incomes;
determining, based upon the evaluating, a risk status associated with the borrower's ability to repay the loan; and
producing an output based upon the determined risk status.

23. A non-transitory computer readable storage medium tangibly storing instructions that, when executed by at least one processor of a system for verifying a borrower's ability to repay a loan, perform operations comprising:
receiving first information related to the borrower;
determining, based on the received first information, a set of educational modules and a set of verification questions;
collecting second information related to the borrower based upon responses provided by the borrower in real-time to a series of questions presented, wherein questions for the series are determined from the set of verification questions dynamically based upon the first information and said responses so far collected, and wherein during the collecting the borrower is provided access to one or more educational modules in the set of educational modules selectively based upon the first information and said responses so far collected;
determining, based upon the first information and the second information, a ratio of a residual income to an average gross income for the borrower;
evaluating the ratio based upon a predetermined set of rules associating average gross incomes and residual incomes;
determining, based upon the evaluating, a risk status associated with the borrower's ability to repay the loan; and
producing an output based upon the determined risk status.
